(19) United States
(12) Patent Application Publication
(10) Pub. No.: US 2014/0132274 A1
(43) Pub. Date: May 15, 2014

(54) METHOD AND APPARATUS FOR PROVIDING INFORMATION IN AN ELECTROLYTE MEASURMENT SYSTEM

(71) Applicant: AWARENESS TECHNOLOGY INC., Palm City, FL (US)

(72) Inventors: Gary Freeman, Palm City, FL (US); Doug Shields, Stuart, FL (US)

(73) Assignee: AWARENESS TECHNOLOGY INC., Palm City, FL (US)

(21) Appl. No.: 14/077,836

(22) Filed: Nov. 12, 2013

Related U.S. Application Data
(60) Provisional application No. 61/725,545, filed on Nov. 13, 2012.

(51) Int. Cl. G01N 27/26

(52) U.S. Cl. CPC G01N 27/26
USPC 324/425

(57) ABSTRACT

An electrolyte measurement assembly includes an electrolyte measurement system having removable components including a removable reagent pack and at least one removable electrode and a computer chip embedded in at least one of the removable components, the computer chip having a memory and providing and receiving data about usage and condition of the at least one removable component.

### CROSS-REFERENCE TO RELATED APPLICATIONS

This application claims priority to U.S. Provisional Application Ser. No. 61/725,545, filed on Nov. 13, 2012), the entire disclosure of which is hereby incorporated herein by reference in its entirety.

### FIELD OF THE INVENTION

The present invention lies in the field of chemical analysis. The present disclosure relates to methods and apparatuses for measurement of electrolyte levels in fluids.

### BACKGROUND OF THE INVENTION

Electrolytes are ions (dissolved salts) that are found in the body. Because ions have a charge, they have the capacity to conduct electricity. Electrolytes such as sodium, potassium, and chloride (and others) are critical in allowing cells to generate energy, maintain the stability of their walls, and to function in general. They generate electricity, contract muscles, move water and fluids within the body, and participate in myriad other activities.

Sensors in specialized kidney cells monitor the amount of sodium, potassium, and water in the bloodstream. The body functions in a very narrow range of normal, and it is hormones that keep the electrolyte balance within those normal limits. Keeping electrolyte concentrations in balance also includes stimulating the thirst mechanism when the body gets dehydrated.

Electrolytes play a vital role in maintaining homeostasis within the body. They help to regulate myocardial and neurological function, fluid balance, oxygen delivery, acid-base balance, and much more. Electrolyte imbalances can develop by the following mechanisms: excessive ingestion; diminished elimination of an electrolyte; and diminished ingestion or excessive elimination of an electrolyte. Common causes of electrolyte disturbances include vomiting, severe diarrhea, dehydration, and renal failure. People suffering from bulimia or anorexia nervosa are at especially high risk for an electrolyte imbalance.

The most serious electrolyte disturbances involve abnormalities in the levels of sodium, potassium, and/or calcium. Other electrolyte imbalances are less common, and often occur in conjunction with major electrolyte changes.

Because serious complications can occur due to an electrolyte imbalance, electrolyte analyzers are frequently located in emergency rooms, critical care wards, dialysis clinics, and other areas where care providers have instant access to test results. It is imperative that the components of the electrolyte measurement system are in proper working order and that the systems remain active and calibrated at all times. Present systems that measure electrolyte levels in bodily fluids are not equipped to provide information about components of the system. There is presently no way to automatically obtain diagnostic information about components of the electrolyte measurement system or its readiness to provide a quick reliable result.

Thus, a need exists to overcome the problems with the prior art systems, designs, and processes as discussed above.

### SUMMARY OF THE INVENTION

The invention provides methods and apparatuses for providing information in an electrolyte measurement regarding electrolyte levels in fluids that overcomes the hereinafore-mentioned disadvantages of the heretofore-known devices and methods of this general type and that provide such features with a computer chip for various components.

With the foregoing and other objects in view, there is provided, in accordance with the invention, an electrolyte measurement system having one or more removable components. A computer chip is embedded in each of the one or more removable components. Each computer chip provides and receives data about the usage and condition of the one or more components.

In accordance with another feature of the invention, the computer chip is a memory chip.

In accordance with an added feature of the invention, data is stored in on or more storage units of the memory chip.

In accordance with an additional feature of the invention, data is written into independent storage units of the memory chip.

In accordance with yet another feature of the invention, data is written to at least one independent storage unit and locked by a manufacturer of the electrolyte measurement system.

In accordance with yet a further feature of the invention, wherein data is written to at least one independent storage unit and locked when the memory chip is first placed in the electrolyte measurement system.

In accordance with yet an added feature of the invention, data written to at least one independent storage unit is updated with each use and remains unlocked.

In accordance with yet an additional feature of the invention, there is provided firmware installed as part of an electronic control of the electrolyte measurement system that communicates with the computer chip.

In accordance with again another feature of the invention, when the electrolyte measurement system is unable to communicate with the computer chip, the electrolyte measurement system is disabled.

In accordance with again a further feature of the invention, contacts of the computer chip are mechanically positioned such that the electrolyte measurement system is able to communicate with the computer chip.

In accordance with again an added feature of the invention, when the electrolyte measurement system is unable to communicate with the computer chip of the component, the electrolyte measurement system is disabled.

In accordance with again an additional feature of the invention, the one or more components include at least one of one or more electrodes and a reagent pack.

In accordance with still another feature of the invention, data is written to the computer chip to indicate a current status of the electrode or reagent pack.

In accordance with still a further feature of the invention, at least one of the one or more electrodes and the reagent pack is disabled based on the data.

In accordance with still an added feature of the invention, usage data remains stored in the computer chip of the reagent pack.

In accordance with still an additional feature of the invention, variable data is stored in the computer chip.

In accordance with another feature of the invention, the electrolyte measurement system automatically adjusts internal parameters to the variable data stored in the computer chip.

In accordance with a further feature of the invention, an analog measuring printed circuit board has an embedded computer chip.

In accordance with an additional feature of the invention, five embedded computer chips communicate with the electrolyte measurement system.

In accordance with a concomitant feature of the invention, one of the embedded computer chips is located on a permanent component and four of the embedded computer chips are embedded in removable components.

Although the invention is illustrated and described herein as embodied in methods and apparatuses for providing information in an electrolyte measurement regarding electrolyte levels in fluids, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is a block and schematic diagram of an exemplary embodiment of a system for measuring electrolytes using ion-selective electrodes;

FIG. 2 is a perspective front view of an exemplary embodiment of ion selective electrodes;

FIG. 3 is a photograph of a perspective view of one of the ion-selective electrodes of FIG. 2 disassembled;

FIG. 4 is a photograph of a fragmentary, perspective view of an exemplary embodiment of a reference electrode;

FIG. 5 is a photograph of a rear perspective view of an exemplary embodiment of an ion-selective electrode with an embedded memory chip;

FIG. 6 is a photograph of a side perspective view of the ion-selective electrode of FIG. 5;

FIG. 7 is a photograph of a side perspective view of an exemplary embodiment of a reagent pack;

FIG. 8 is photograph of an exemplary embodiment of a receptacle used to connect the reagent pack of FIG. 7 with the system of FIG. 9.

FIG. 9 is a photograph of a perspective view of an exemplary embodiment of a device implementing the system of FIG. 1; and

FIG. 10 is a photograph of a rear perspective view of the device of FIG. 9.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for the purpose of describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software,” “software application,” and the like as used herein, are defined as a sequence of instructions designed for execution on a computer system. A “program,” “software,” “application,” “computer program,” or “software application” may include firmware, a subroutine, a function, a procedure, an object method, an object implementation, an executable application, an applet, a servlet, a source code, an object code, a shared library/dynamic load library and/or other sequence of instructions in machine language or a higher language designed for execution on a computer system or device.

Herein various embodiments of the present invention are described. In many of the different embodiments, features are similar. Therefore, to avoid redundancy, repetitive description of these similar features may not be made in some circumstances. It shall be understood, however, that description of a first-appearing feature applies to the later described similar feature and each respective description, therefore, is to be incorporated therein without such repetition.

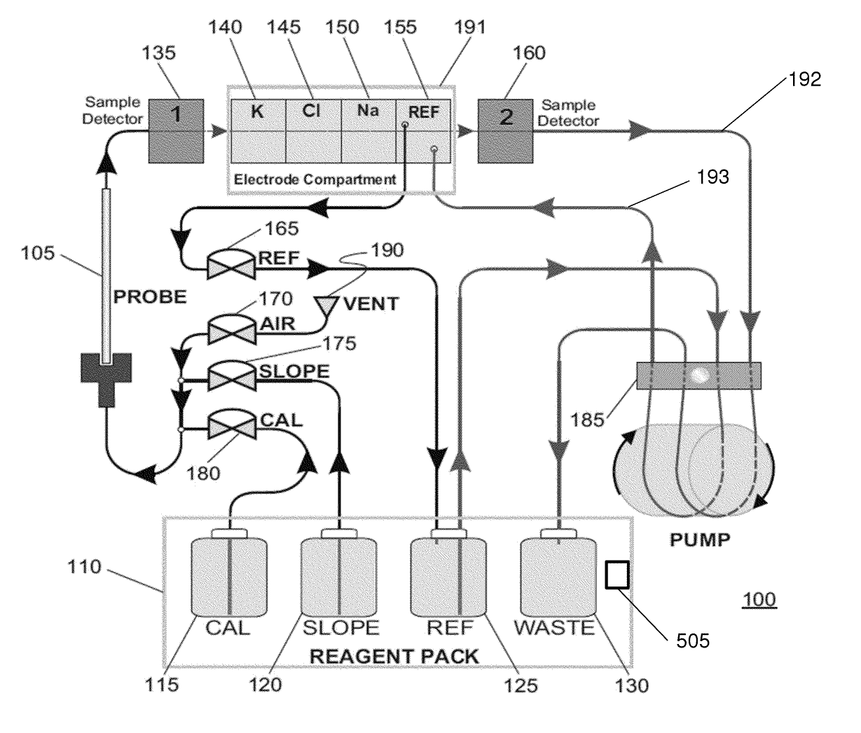

Described now are exemplary embodiments of the present invention. Referring now to the figures of the drawings in detail and first, particularly to FIG. 1, there is shown a first exemplary embodiment of a system 100 for measuring electrolytes using ion-selective electrodes. A sample (not shown) is aspirated into a probe 105 which is then closed, as shown in FIG. 1. This sample is, then, pumped through the system in the direction of the arrows through the electrode compartment 191 for measurement before being dispensed into the waste container 130, as shown by path 192 and the arrows therein. A reagent pack 110 is provided with all fluids necessary for the system to calibrate itself and to make sample measurements based on that calibration. The reagent pack 110 includes a calibration fluid receptacle 115, a slope fluid receptacle 120, a reference fluid receptacle 125, and a waste receptacle 130. The calibration fluid and slope fluid are sequentially pumped from the reagent pack 110 using a peristaltic pump 185 and valves 175, 180. Air pumped through vent 190 using pump 185 and valve 170, clears the tubing between use of the calibration fluid and of the slope solution. Air is used again to clear out these solutions before reading a sample and, again, to clear out a sample after measurements are made. Calibration solution is also used to wash out the lines to prevent carry over. The air, the calibration fluid, and the slope fluid are used first to measure the system without a sample (two-point calibration). After that, calibration fluid is moved through the system to maintain a slight forward pressure and to equilibrate the system at the ion concentrations of the calibration fluid. A sample detector 135 detects the presence or absence of fluid at that point in the system and serves to indicate the arrival of material into the electrode compartment 191. Ion-selective electrode (ISE) assemblies 140, 145, 150 are used to detect electrolyte levels for Potassium, Chloride, and Sodium for the calibration solution or the sample in conjunction with a reference electrode 155 that uses the reference fluid. The reference fluid is pumped from the reference fluid receptacle 125 of the reagent pack 110 to the reference electrode 155 along path 193 using the pump 185. A valve 165 is used to return the reference fluid to the reference fluid receptacle 125. Each electrode 140, 145, 150 has a membrane that ideally allows only one respective ion to pass through.

In use, the sample in the probe 105 is introduced to each electrode through its respective membrane that abuts the sample channel. As the two sides of the membrane come to equilibrium, osmosis and diffusion of ions creates a voltage with respect to the reference electrode 155. Voltage is measured to determine a concentration of a particular ion, i.e., Potassium, Chloride, and/or Sodium. A sample detector 160 detects the presence of fluid exiting the electrode compartment 191. The pump 185 then pumps the waste fluid to the waste receptacle 130 of the reagent pack 110. Fluids, e.g., the slope and calibration fluids, with known standard concentrations and a known voltage level are used to create a linear calibration curve from the fluids for use as a reference.

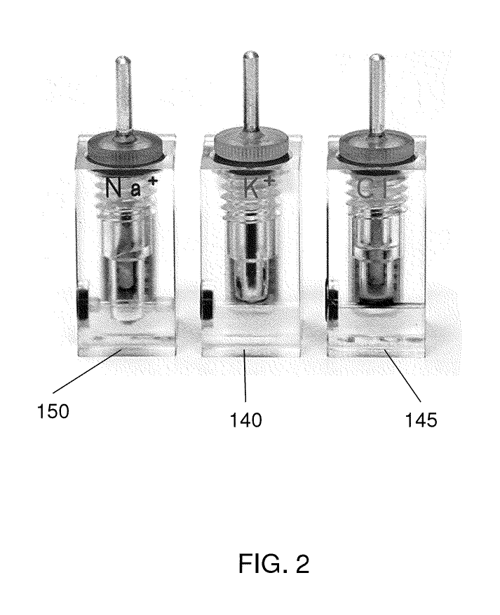

FIG. 2 shows various ISE assemblies 140, 145, 150. ISE 140 is operable to detect Potassium. ISE 145 is operable to detect Chloride. ISE 150 is operable to detect Sodium.

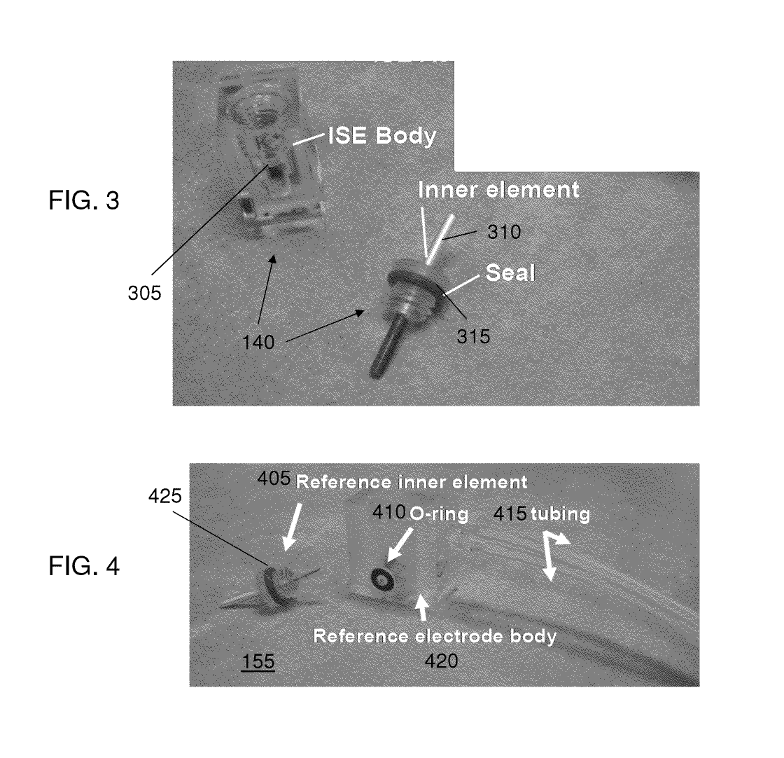

FIG. 3 provides another illustration of an ISE assembly (e.g., ISE assembly 140) in an un-assembled state and having an ISE body 305 and a portion having an inner element 310 and a seal 315.

FIG. 4 illustrates a reference electrode 155 in an un-assembled state. The reference electrode 155 has a reference electrode body 420 that includes an O-ring 410 and tubing 415. The reference electrode 155 also includes another portion having a reference inner element 405 and a seal 425.

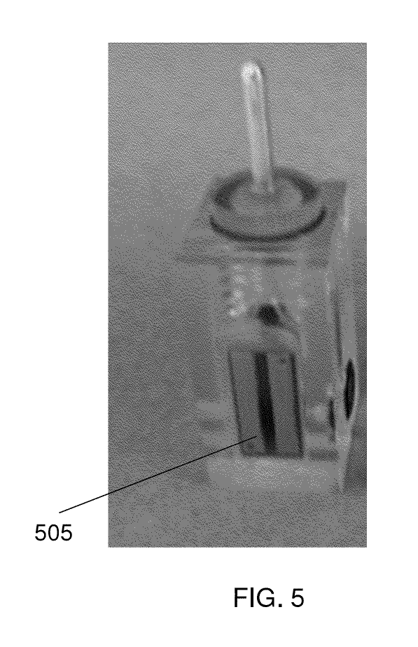

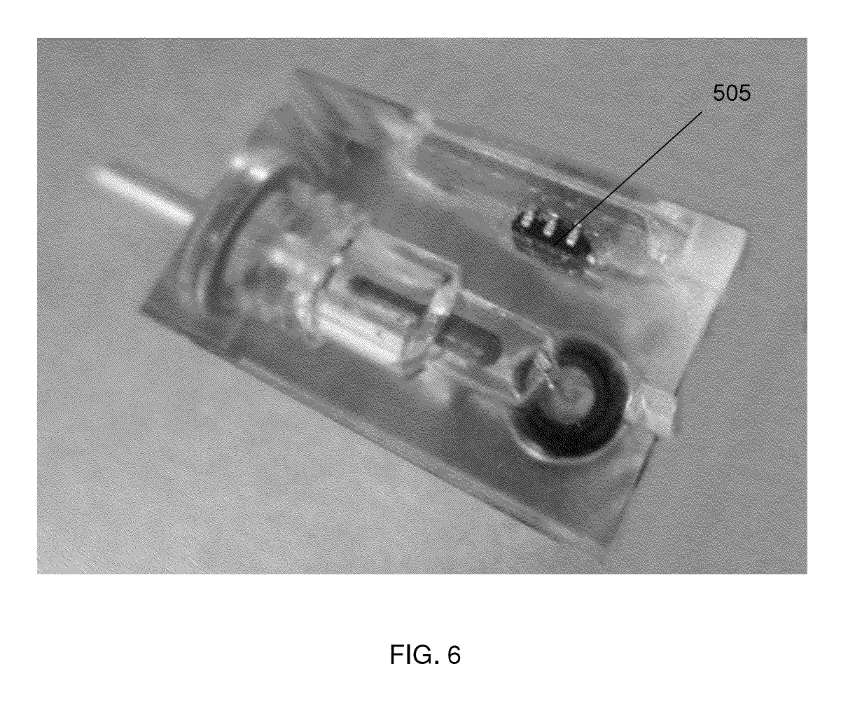

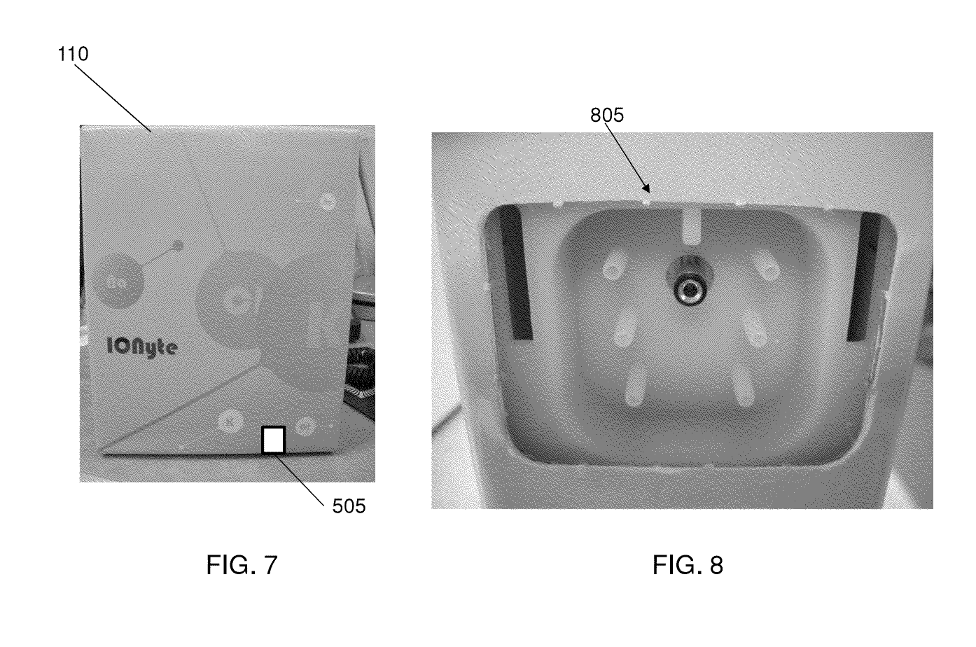

FIG. 5 illustrates one ISE assembly (e.g., one of ISE assemblies 140, 145, 150) having a computer chip 505 embedded therein. The computer chip 505 can be used as a memory chip. In one exemplary embodiment, the memory chip is a Maxim Integrated™ DS2431 EEPROM chip. The memory chip 505 is also embedded in the reagent pack 110 (see, e.g., FIGS. 7 and 8) and can also be integrated with permanent components of the system 100. FIG. 6 illustrates a side view of an ISE assembly having such a memory device 505.

FIG. 7 illustrates an example of the reagent pack 110. The memory chip 505 for the reagent pack is shown only diagrammatically in FIG. 7 (see also FIG. 1). FIG. 8 illustrates an exemplary embodiment of a receptacle 805 that is used to plug the reagent pack into the system 100.

The system 100 uses memory chips that are embedded in strategic removable or replaceable components. The memory chips store data about the usage and condition of the components. This data is very useful for tracking the use and health of each component as well as providing information useful in diagnosing service issues.

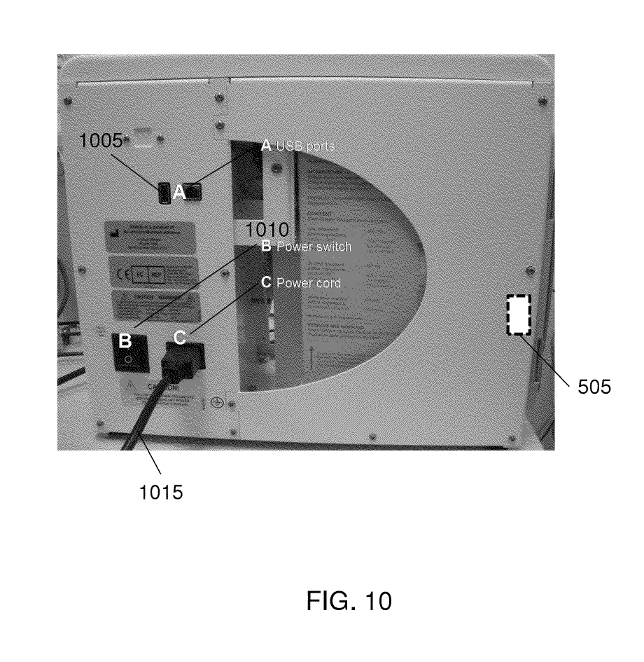

In one exemplary embodiment, there are five memory chips in each system 100. One memory chip 505 is located on the analog measuring printed circuit board (illustrated diagrammatically in FIG. 10). This part is permanently set in place (e.g., soldered) and stays with the system 100. A second memory chip 505 is located in the reagent pack 110 (see, e.g., FIG. 1). The chip 505 is, therefore, replaced with each new reagent pack. There are three additional memory chips 505 located in each of the three ISE electrodes 140, 145, 150. These parts 505 are embedded into the body of the electrode (as shown, for example, in FIGS. 2, 5, and 6) and, therefore, are renewed with each replacement of an electrode 140, 145, 150.

Each memory chip 505 has the capacity to store 1024 bits of information. Every chip 505 also has a unique, unalterable 64-bit registration number that is written by laser into the chip 505 by the manufacturer. Data is written into four independent “pages” of 256 bits each. Some pages are written and locked by the manufacturer of the system 100. This information, such as serial, lot number, and expiration date can never be altered. Other pages may be written and locked when the memory chip 505 is first placed into the system 100. This data may include a date of first use or initial calibration data. The remaining page is used to store data such as number of samples taken, health of the electrodes, or percent of fluids remaining in the reagent pack 110. This information is updated with each use and is not locked.

The memory chip 505 in the reagent pack 110 is permanently attached (e.g., soldered) to a coaxial barrel connector. The connector is glued to the reagent pack fluid connector and becomes a permanent part of the reagent pack 110. The reagent pack connector removably connects to a mating connector in the middle of the fluid connector on the instrument, i.e., system 100. Firmware installed as part of the electronic control of a system such as System 100 communicates with the memory chip 505. If the system 100 cannot communicate with the memory chip 505 in the reagent pack 110, indicating the reagent pack 110 is not installed properly or, perhaps a counterfeit pack is fitted, the system 100 will be disabled. The system 100 could likewise reject a reagent pack that is fully consumed or older than its expiration date.

Each ISE electrode 140, 145, 150 has a memory chip 505 that is fastened (e.g., soldered) to a small printed circuit board. The circuit board is, for example, attached by epoxy into the back of the body of the electrode 140, 145, 150. Thus, the memory chip 505 becomes an integral part of the ISE electrode 140, 145, 150. In an exemplary configuration, two large gold-plated contacts on the back of the circuit board connect to spring loaded connectors within the electrode compartment of the system 100.

Mechanical positioning of the contacts is important because, if the system cannot communicate with the memory chip 505, the system will not allow readings from that ISE. This safety prevents use of counterfeit sensors (e.g. electrodes) in or with the system 100. In addition, if a user places the sensor in the wrong location, the system 100 is able to identify the misplaced sensor and direct the user to place the sensor in the proper location.

Signals from each memory chip 505 are directed to an interface circuit (not shown) located on the analog measuring printed circuit board of the system 100. This interface handles the unique communications protocol with each memory chip 505. In one exemplary embodiment, communications with each memory chip 505 is constantly maintained by the system 100 through a bi-directional serial protocol. As each sample or calibration is completed, data is written to the memory chip 505 to indicate the current status of each electrode 140, 145, 150 or the reagent pack 110. If communication is lost, indicating removal of that component, the system 100 becomes aware of the removal and is able to react accordingly. The interface circuit of the system 100 allows for additional chips 505 (e.g., eight chips 505) to be connected to provide capacity for expansion, e.g., in excess of the embodiment where five memory chips 505 are used, if needed. Data is communicated from the interface chip to the microcontroller via an industry standard I2C connection, for example.

In the reagent pack 110, information recorded can, for example, indicate that the pack 110 has reached its expiration date or that one or more of the fluids is/are exhausted. The reagent pack 110 can be disabled, respectively. This ability to disable the reagent pack 110 prevents the use of expired reagents Likewise, if a user attempted to refill a reagent pack 110 with unauthorized fluids, the system 100 is able to detect that more than 100% of the fluids have been used and to take action to disable the reagent pack 110. For example, information can be written into the memory 505 of the reagent pack 110 to indicate that this reagent pack 110 is no longer authorized for use, i.e., to disable it. Once disabled, the reagent pack 110 cannot be used in any system 100.

The connection of the reagent pack 110 to the mating connector on the system 100 is positioned so that the reagent pack 110 is connected only after the fluid connections are completed. If the system 100 is not able to communicate with the memory chip 505, the system 100 indicates that the reagent pack 110 is not installed properly. An improperly installed reagent pack 110 can lead to poor performance or faulty readings.

The memory chip 505 of the reagent pack 110 stores data including, for example, the lot number, the expiration date (which is based on date of first installation), exact values of calibration fluids, and the number of calibrations and samples read with that reagent pack 110. In previous systems, if a reagent pack was changed, the instrument would reset the pack to being 100% full. However, if that pack had been previously used, this assumption would not be accurate. In the present system 100, however, using a reagent pack 110 with a memory chip 505 allows the usage data to stay with the respective, unique reagent pack 110. Thus, a partially used reagent pack 110 will maintain correct data about the percent of fluids remaining at all times. This is important, for example, to warn a user that fluids are low to prevent an unexpected situation where the pack 110 runs out of one or more fluids during a use cycle, which state would disable the system 100.

The memory chip 505 in each electrode 140, 145, 150 records a number of characteristics including, for example, an expiration date of the electrode 140, 145, 150, a wet life limit, numbers of calibrations and samples performed, and calibration data. If the expiration date or wet life limits are reached, the electrode 140, 145, 150 can be disabled (e.g., by writing disable data to the memory chip 505 of the respective electrode 140, 145, 150). If the response of the electrode 140, 145, 150 drops below an acceptable level(s), the system 100 is able to issue a warning to the user that the electrode 140, 145, 150 should be refilled or replaced. Again, once disabled by using the on-board memory chip 505, the particular electrode 140, 145, 150 cannot be used in any system 100.

Another unique aspect of the memory chip 505 in the system 100 is that variable data can be stored in the chips 505. For instance, if a particular application calls for unique values of calibration fluids, the values of fluid concentrations can be stored in each of these special reagent packs 110. When the pack 110 is placed in the system 100, the system 100 automatically adjusts its internal parameters to the values of that particular pack 110.

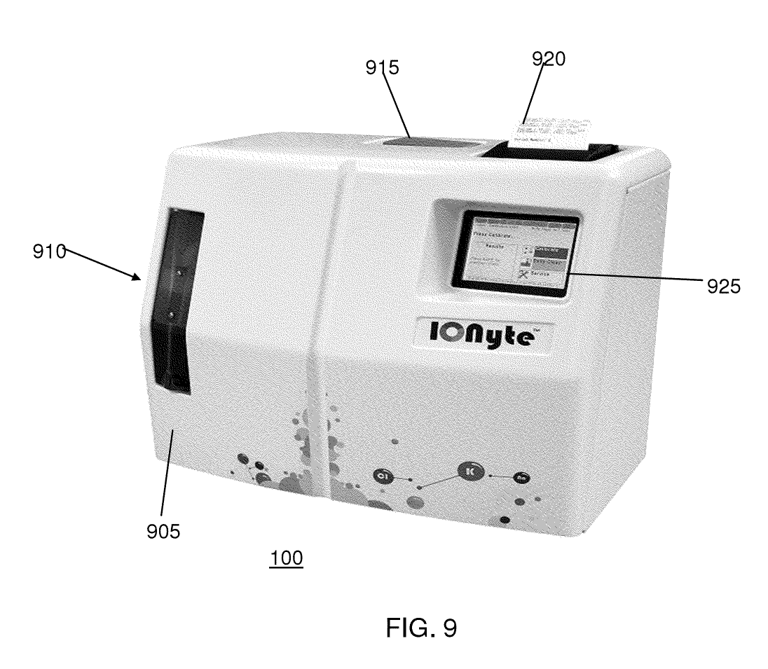

An exemplary configuration of the system 100 is shown in FIGS. 9 and 10. In this configuration, all of the information stored in the memory chips 505 of the system 100 can be viewed on a display 925. The information can also be saved to a file, for example, on a USB flash memory device plugged into a USB socket on the instrument, e.g., USB socket 1005 (A). This file can be transmitted to a service agent or to the factory for diagnostic use either directly or indirectly. This information aids in resolving any or all service issues, which are not easily resolved in the field.

FIG. 9 shows a perspective view of a device that implements the system 100. The device 100 has a front cover 905, a probe shield 910, a lever 915 that is used during installation and removal of the reagent pack 110, an internal printer 920, and a display 925. The display 925 may be an interactive touch screen liquid crystal color display, for example. FIG. 10 illustrates a rear view of the device 900. Also shown in FIG. 10 are USB ports 1005, a power switch 1010, and a power cord 1015.

As stated previously, data is stored on each memory chip 505 of an ISE. This data is stored in “pages” of the memory chip 505. As used herein, pages are used merely as exemplary descriptors and can be storage units in any format known to those skilled in the art. Also, for the various datum stored on the pages, the datum types described herein form an exemplary embodiment. Other datum types are envisioned as well.

Page 1 of each memory chip 505, which is locked at the time of manufacture stores, for example, Serial Number, Type, Lot Number, Shelf Expiration Date, and a Theoretical Delta used to compare the condition of the electrode to minimum acceptable standards. The Serial Number is a unique number assigned only to one of the electrodes 140, 145, 150. The electrode Type, for example, identifies whether the ISE is operable to sense Potassium, Chloride, or Sodium. The Lot Number, for example, is the manufacturing lot number assigned by the manufacturer. The Shelf Expiration Date is an expiration date of the ISE if it is not used in a system 100. The Theoretical Delta is the minimum acceptable delta millivolt value.

Page 2 of each memory chip 505, which is locked during quality control testing by the manufacturer, stores, for example, Wet Life Limit, Maximum Cycle Count, Check Cal Date, Check Cal my, and Check Cal Delta. The Wet Life Limit is a number of hours with fill solution in the electrode. The Maximum Cycle Count is a maximum number of calibrations and samples. The Check Cal Date is a date that the electrode was tested. The Check Cal my is a millivolt response to Cal fluid during testing. The Check Cal Delta is a delta millivolts between calibration and slope fluids.

Page 3 of each memory chip 505, which is locked when the electrode is first installed in a user instrument, stores First Used Date, First Cal Delta, First Cal my, and Expiration Date. The First Used Date is a date the ISE was first installed by a consumer. The First Cal Delta is a delta my response at first calibration by the consumer. The First Cal my is a millivolt response from the time of first calibration by the consumer. Finally, the Expiration Date is the current date plus the Wet Life Limit hours.

Page 4 of each memory chip 505, which is not locked, stores, for example, Last Used Date, Last Used Time, Last Cal Date, Last Cal Delta, Last Cal my, Sample Count, Cal Count, Last Power Update, Last Power Uptime, Power Up Count, and Minutes Under Power. The Last Used Date is the date of the last sample taken. The Last Used Time is a time that the last sample was taken. The Last Cal Date is a date when the last calibration occurred. The Last Cal Delta is a delta my value between the calibration and the slope at the last calibration. The Last Cal my is a millivolt response to Cal fluid at the last calibration. The Sample Count is a number of samples read by the electrode. The Cal Count is a number of calibration cycles undertaken by the electrode. The Last Power Update is a date that the instrument was last powered on. The Last Power Uptime is a time that the instrument was last powered on. The Power Up Count is a number of times powered on with the electrode. The Minutes Under Power is a number of minutes the electrode has been in use.

Data is also stored on each memory chip 505 of a reagent pack 110. This data is stored in “pages” of the memory chip 505. Page 1, which is locked at the time of manufacture, stores Type, Lot Number, Expiration Date, Cal Fill Volume, Slope Fill Volume, and Ref Fill Volume. The Type identifies the specific model of the reagent pack 110. The Lot Number is the manufacturer lot number. The Expiration Date is the expiration date of the reagents. The Cal Fill Volume is the volume of calibration fluid in the reagent pack 110. The Slope Fill Volume is the volume of slope fluid in the reagent pack 110. The Ref Fill Volume is the volume of reference fluid in the reagent pack 110.

Page 2 of the memory chip 505, which is locked during quality control testing by the manufacturer, stores Lot Number, Wet Life Limit, Maximum Cycle Count, K Cal Concentration, K Slope Concentration, Na Cal Concentration, Na Slope Concentration, Cl Cal Concentration, Cl Slope Concentration, xx Cal Concentration, xx Slope Concentration, and Ref Concentration. The Lot Number is the manufacturer lot number. The Wet Life Limit is the number of hours with fill solution in the electrode. The Maximum Cycle Count is the maximum number of calibrations and samples. The K Cal Concentration is the Potassium concentration in mmol/l of calibration fluid. The K Slope Concentration is the Potassium concentration in mmol/l of slope fluid. The Na Cal Concentration is the Sodium concentration in mmol/l of calibration fluid. The Na Slope Concentration is the Sodium concentration in mmol/l of slope fluid. The Cl Cal Concentration is the Chloride concentration in mmol/l of calibration fluid. The Cl Slope Concentration is the Chloride concentration in mmol/l of slope fluid. The xx Cal Concentration is the optional concentration in mmol/l of calibration fluid. The xx Slope Concentration is the optional concentration in mmol/l of slope fluid. The Ref Concentration is the Potassium Chloride concentration in mol/l of reference fluid.

Page 3 of the memory chip 505, which is locked after first user by the consumer stores First Used Date and Serial Number of first instrument used. The First Used Date is the date the reagent pack was first installed by the consumer. The Serial Number of the first instrument used is the serial number of the first instrument where the reagent pack was used.

Page 4 of the memory chip 505, which is not locked, stores Last Used Date, Last Used Time, Serial Number Last Connected, Sample Count, Calibration Count, Last Power Up Date, Last Power Up Time, Power Up Count, Minutes Under Power, Wet Mode Volume, and Daily Clean Count. The Last Used Date is the date of last sample or calibration. The Last Used Time is the time of last sample or calibration. The Serial Number Last Connected is the serial number of the last instrument where the reagent pack was used. The Sample Count is the number of samples read with the reagent pack. The Calibration Count is the number of calibrations done with the reagent pack. The Last Power Up Date is the date the system 100 was last powered up. The Last Power Up Time is the time the system 100 was last powered up. The Power Up Count is the number of times power has been applied. The Minutes Under Power is the time the pack has been in use. The Wet Mode Volume is the rate of fluid consumption in a wet mode. The Daily Clean Count is the number of clean cycles performed with the reagent pack.

Data is also stored on the memory chip 505 of the analog measuring printed circuit board. This data is stored in various forms in “pages” of the memory chip in the exemplary embodiment. Page 1 of the memory chip 505, which is locked at the time of manufacture, stores Serial Number, Type, Model, and Lot Number. The Serial Number is a unique serial number of the circuit board. The Type indicates the chip is on the analog board. The Model is a model number of the device where the memory chip is installed. The Lot Number is a manufacturer's lot number of the board.

Page 2 of the memory chip 505, which is locked at the time of manufacture, stores Serial Number and Lot Number. The Serial Number is a unique serial number of the circuit board. The Lot Number is the manufacturer's lot number of the circuit board.

Page 3 of the memory chip 505, which is locked after first use in a system, stores First Used Date, which is the date that circuit board was first installed in the instrument.

Page 4 of the memory chip 505, which is not locked, stores Last Used Date, Last Used Time, Last Cal Date, Sample Count, Last Power Up Date, Last Power Up Time, Power Up Count, and Minutes Under Power. The Last Used Date is the date of last calibration or sample. The Last Used Time is the time of last calibration or sample. The Last Cal Date is the date of last calibration. The Sample Count is the number of samples read by the respective board. The Last Power Up Date is the date that the instrument was last turned on. The Last Power Up Time is the time that the instrument was last turned on. The Power Up Count is the number of time power has been applied. The Minutes Under Power is the number of minutes that the board has been operating.

The system 100 may be programmed with specialized firmware that facilitates the programming of the chip 505 one by one or in batches at the time of device manufacturing. Such firmware may include automatic scanning for connected devices and detection for events such as non-programmed fields, programming errors, and information programmed outside of acceptance ranges. Such specialized firmware has the capability of determining if an ISE electrode is performing acceptably, is recording specific performance data, and is permanently locking pages of recorded data. The firmware may also generate printed Certificate of Quality reports of programmed devices as a permanent Quality Control record.

This invention includes additional and alternative information posted to and read from the chip 505 for the purposes of directing the operator, protecting the integrity of the system, maintenance of the system and troubleshooting of the system. Such software enhancements might also include passwords, handshakes, check sums and use of higher-level encryption to safeguard information programmed to the chip 505.

It is noted that various individual features of the inventive processes and systems may be described only in one exemplary embodiment herein. The particular choice for description herein with regard to a single exemplary embodiment is not to be taken as a limitation that the particular feature is only applicable to the embodiment in which it is described. All features described herein are equally applicable to, additive, or interchangeable with any or all of the other exemplary embodiments described herein and in any combination or grouping or arrangement. In particular, use of a single reference numeral herein to illustrate, define, or describe a particular feature does not mean that the feature cannot be associated or equated to another feature in another drawing figure or description. Further, where two or more reference numerals are used in the figures or in the drawings, this should not be construed as being limited to only those embodiments or features, they are equally applicable to similar features or not a reference numeral is used or another reference numeral is omitted.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. An electrolyte measurement assembly, comprising:
an electrolyte measurement system having removable components including a removable reagent pack and at least one removable electrode; and
a computer chip embedded in at least one of the removable components, the computer chip having a memory and providing and receiving data about usage and condition of the at least one removable component.

2. The electrolyte measurement system of claim 1, wherein the computer chip is embedded in each of the removable components.

3. The electrolyte measurement system of claim 2, wherein the electrolyte measurement system stores the data in the memory of the computer chip.

4. The electrolyte measurement system of claim 3, wherein:
the memory has independent storage units; and
the electrolyte measurement system writes data into the independent storage units.

5. The electrolyte measurement system of claim 4, wherein the data written to at least one of the independent storage units is locked by a manufacturer of the electrolyte measurement system.

6. The electrolyte measurement system of claim 4, wherein the data written to at least one of the independent storage units is locked when the computer chip is first placed in the electrolyte measurement system.

7. The electrolyte measurement system of claim 4, wherein the data written to at least one of the independent storage units is updated with each use of the electrolyte measurement system and remains unlocked.

8. The electrolyte measurement system of claim 1, wherein the electrolyte measurement system has firmware for an electronic control to communicate with the computer chip.

9. The electrolyte measurement system of claim 1, wherein the electrolyte measurement system is disabled when the electrolyte measurement system is unable to communicate with the computer chip.

10. The electrolyte measurement system of claim 1, wherein the computer chip has contacts mechanically positioned to communicate with the electrolyte measurement system.

11. The electrolyte measurement system of claim 10, wherein the electrolyte measurement system is disabled when the electrolyte measurement system is unable to communicate with the computer chip.

12. The electrolyte measurement system of claim 1, wherein the at least one removable electrode is a plurality of electrodes.

13. The electrolyte measurement system of claim 1, wherein the electrolyte measurement system writes data to the computer chip to indicate a current status of at least one of the removable components.

14. The electrolyte measurement system of claim 1, wherein the electrolyte measurement system disables at least one of the removable components based on the data.

15. The electrolyte measurement system of claim 1, wherein:
the reagent pack has the computer chip; and
the electrolyte measurement system stores the data about usage in the computer chip of the reagent pack.

16. The electrolyte measurement system of claim 1, wherein the electrolyte measurement system stores variable data in the computer chip.

17. The electrolyte measurement system of claim 16, wherein the electrolyte measurement system automatically adjusts internal parameters to the variable data stored in the computer chip.

18. The electrolyte measurement system of claim 1, further comprising an analog measuring printed circuit board having an embedded computer chip.

19. The electrolyte measurement system of claim 18, wherein the removable components and the printed circuit board have five embedded computer chips that communicate with the electrolyte measurement system.

20. The electrolyte measurement system of claim 19, wherein one of the embedded computer chips is located on a permanent component of the electrolyte measurement system and four of the embedded computer chips are embedded in the removable components.
